(19) United States
(12) Patent Application Publication
(10) Pub. No.: US 2010/0241758 A1
(43) Pub. Date: Sep. 23, 2010

(54) SYSTEM AND METHOD FOR HARDWARE ACCELERATED MULTI-CHANNEL DISTRIBUTED CONTENT-BASED DATA ROUTING AND FILTERING

(76) Inventors: John Oddie, Heathfield (GB); Ken Tregidgo, Acton (GB)

Correspondence Address: The Marbury Law Group, PLLC, 11800 SUNRISE VALLEY DRIVE, SUITE 1000, RESTON, VA, 20191, US

(21) Appl. No.: 12/705,114

(22) Filed: Feb. 12, 2010

Related U.S. Application Data
(63) Continuation of application No. 12/580,628, filed on Oct. 16, 2009.
Application No. 12/580,628 is a continuation-in-part of application No. 12/580,647, filed on Oct. 16, 2009.
(60) Provisional application No. 61/106,521, filed on Oct. 17, 2008.
(60) Provisional application No. 61/106,526, filed on Oct. 17, 2008.

(51) Int. Cl. G06F 15/80; G06F 9/06; G06F 13/14; G06F 15/16

(52) U.S. Cl. 709/231; 712/17; 710/305; 712/14; 712/E09.003

(57) ABSTRACT

Systems and methods for hardware accelerated multi-channel content-based data routing and filter. Data packets are received at a filtering circuit from one or more sources. The packets are filtered in accordance with parameters established by a system user to select specific information of relevance to the system user. The filtering may be facilitated by the assignment of a content identifier to a data element and routing data elements with the assigned content identifier to a memory associated with a processor core for collection and processing. The filtering, collection and processing is performed without calls to an operating system. The data are then distributed to data consumers over a network for further processing and use.

### CROSS REFERENCE TO RELATED APPLICATIONS

This application is a continuation in part of U.S. application Ser. No. 12/580,628 filed Oct. 16, 2009 and continuation in part of U.S. application Ser. No. 12/580,647 filed Oct. 16, 2009, both of which claimed priority under 35 U.S.C. §119(e) from provisional applications No. 61/106,521 and 61/106,526, both filed Oct. 17, 2008. The Ser. Nos. 12/580,628, 12/580,647, 61/106,521 and 61/106,526 applications are incorporated by reference herein, in their entireties, for all purposes.

### BACKGROUND

The development of computers and data networks has transformed the way we work, communicate and share information. Because the capacity exists to process data, more data is created. The more data that is created, the greater the need for tools to process that data faster and more efficiently. The focus of much of this demand has been on the general purpose computer. Due to the trade-off between clock speed and power density, CPU clock speeds have not been growing as fast as in the past. Around the year 2000, the emphasis changed from increasing performance based primarily on clock speed to performance improvement through parallelization.

With the emergence of multi-core CPU architectures the challenge today is how to get the required data to the right core for processing without consuming that processing power to move the data around. The challenge becomes greater in a fully distributed environment where a good deal of server capacity can be dedicated to examining data for relevance, adding to footprint and total cost of ownership.

However, even with multi-core architectures and improved bus speeds, data manipulation that requires calls to operating systems and other internal data management software affect the overall performance of a data processing application. An operating system (OS) acts as a digital traffic cop that starts and stops processes in an attempt to coordinate all of the demands on the CPU and its peripherals. While efficient from a global view, the operation of the OS introduces delay (the time it takes a path component to process a packet), latency (the aggregate time a packet is delayed by all the components in the path), and jitter (the variation in the arrival time of packets over a particular path). Thus, OS and its peripherals represent a major obstacle to further improvements in data throughput and data processing speeds.

### SUMMARY

Embodiments herein are directed to the routing, filtering and processing of data elements from one or more sources that are received at a network device. The packet is filtered in accordance with parameters established by a system user to select specific information of relevance to the system user. In an embodiment, the filtering is facilitated by the assignment of a routing identifier to a data element and routing data elements with the assigned routing identifier to a processor core for processing and distribution to CPUs for further processing and use.

### DESCRIPTION OF THE DRAWINGS

FIG. 1 is a pictorial schematic representing a system according to an embodiment.

FIG. 2 is a block diagram illustrating a data distribution system according to an embodiment.

FIG. 3 is a block diagram illustrating components of a coprocessor card component of a data injector/translator according to an embodiment.

FIG. 4 is a block diagram illustrating components of an algorithm/strategy container with local execution according to an embodiment.

FIG. 5A is a block diagram illustrating a strategy container with distributed market access according to an embodiment.

FIG. 5B is a block diagram of a shared market access container according to an embodiment.

FIG. 6 is a block diagram illustrating components of an accelerated index container according to an embodiment.

FIG. 7 is a block diagram illustrating components of a data throttling container according to an embodiment.

FIG. 8 is a block drawing illustrating the concepts of a book and a superbook as known in the art.

### DETAILED DESCRIPTION

Embodiments herein are directed to the routing, filtering and processing of data elements from one or more sources that are received at a network device. The packet is filtered in accordance with parameters established by a system user to select specific information of relevance to the system user. In an embodiment, the filtering is facilitated by the assignment of a routing identifier to a data element and routing data elements with the assigned routing identifier to a processor core for processing and distribution to CPUs for further processing and use.

In the description that follows, systems and methods for the filtering and distribution of data elements are described in terms of market data filtering and distribution. However, the description is intended as illustrative of the structural and functional elements of the various systems and methods and is not intended to be limiting.

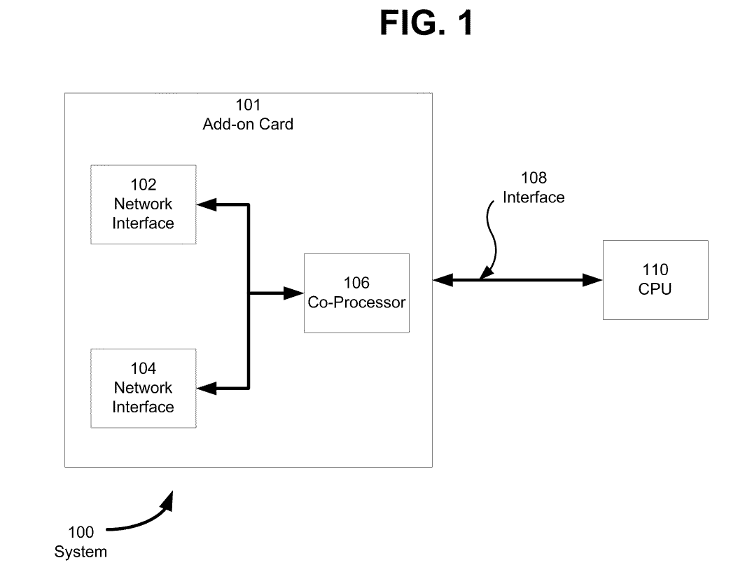

FIG. 1 is a high level pictorial schematic of a system according to an embodiment. The system 100 comprises an add-on card 101 and a CPU 110. The add-on card 101 and the CPU 110 communicate via a high-speed interface 108.

The add-on card 101 comprises a network port 102, a network port 104, and a co-processor 106. In an embodiment, add-on card 101 utilizes a co-processing architecture that may be configured to be plugged-in to a standard network server or stand-alone workstation. As illustrated, add-on card 101 includes network ports 102 and 104, however this is not meant as a limitation. Additional ports may be included on add-on card 101. In an embodiment, the network ports 102 and 104 provided connectivity to wired and fiber Ethernet network interfaces.

The network ports 102 and 104 are interoperably connected to the co-processor 106. The co-processor 106 may be a field programmable gate array (FPGA), an application specific integrated circuit (ASIC), or any form of parallel processing integrated circuit. The direct connection of the network ports to the coprocessor 106 eliminates one of the major contributors to latency in a hardware/software co-processing system that arises from the peripheral bus transactions between the system architecture (the co-processor architecture) and a network device.

The add-on card 101 implements a high-speed interface 108 such as HyperTransport, PCI-Express or Quick Path Interconnect to transfer data to and from the host system central processing unit (CPU) 110 with the highest bandwidth and lowest latency available. In an embodiment, the add-on card 101 is implemented to replace a central processing unit (CPU) in a socket on the motherboard of a host computing device (not illustrated).

Additionally, the system 100 may implement filtering on the content of the messages arriving, which filtering can be customized to a user's needs. By way of illustration and not by way of limitation, filtering may be performed by symbol, message type, price and volume. The filtering process acquires only the information that is of relevance to the user thereby reducing the CPU 110 loads for processing the feed. Messages can also be translated into various binary structures (e.g. Linux, Windows, Java compatible structures as defined by a parameter) that can be read directly from the user's application, avoiding any processing time associated with converting message formats on the CPU 110.

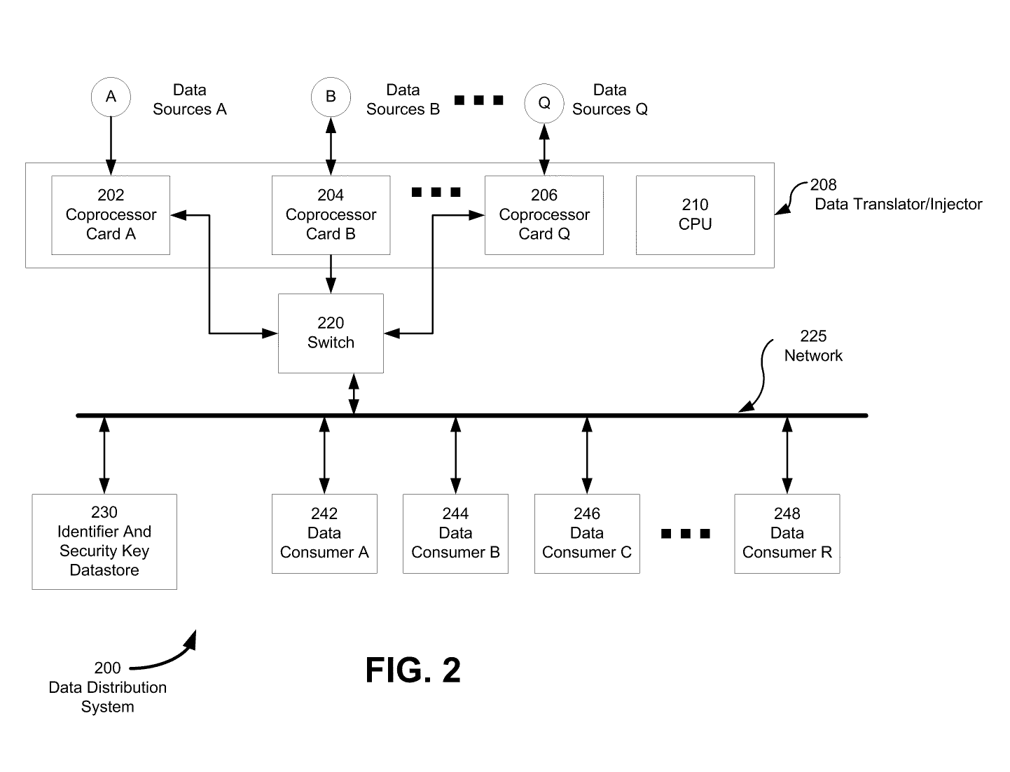

FIG. 2 is a block diagram illustrating a data distribution system according to an embodiment. As illustrated, a data distribution system 200 comprises one or more data injectors, such as data injector 208. The data injector 208 may include one or more coprocessor cards, such as coprocessor cards A-Q (blocks 202, 204 and 206 respectively). The data injector 208 is connected to a network 225 via a switch 220. The network also provides connectivity to an identifier and security key datastore 230 and various data consumers such as data consumers A-R (blocks 242, 244, 246 and 248 respectively). In an embodiment, the network 225 is a fast switched network. By way of illustration and not by way of limitation, the network 225 may be a 10, 40 or 100 GigE network.

In an alternate embodiment, the data injector 208 receives data “off-line” from a data source that is not “real-time.” For example, data may be accumulate in bulk, then processed for distribution over a fast switched network 225 to data consumers A-R (blocks 242, 244, 246 and 248 respectively). While the embodiments described below refer to data acquired via a network, the data filtering, routing, processing and distribution functions may be equally applied to data that is received by other means.

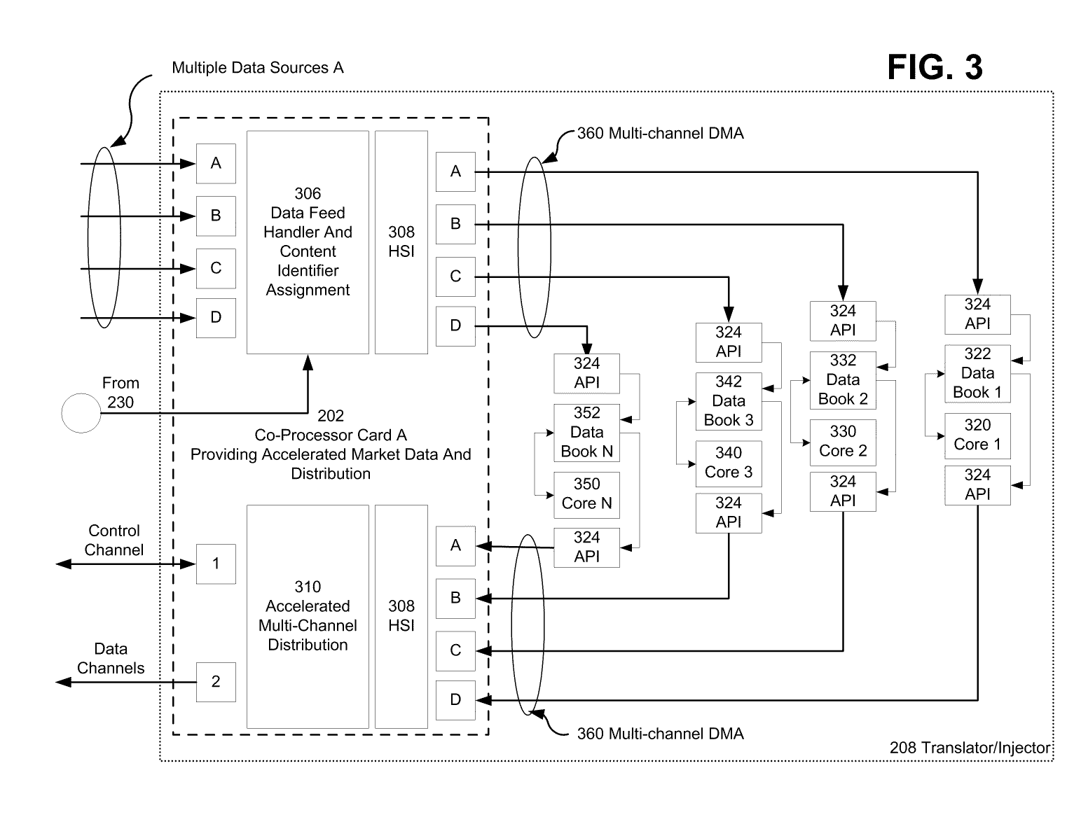

FIG. 3 is a block diagram illustrating components of a coprocessor card component of a data injector/translator according to an embodiment.

FIG. 3 illustrates a translator/injector 208 with additional details of the components of one of the one or more coprocessor cards. As indicated in the description of FIG. 1, the coprocessor card may include one or more co-processors. A coprocessor may be a field programmable gate array (FPGA), an application specific integrated circuit (ASIC), or any form of parallel processing integrated circuit. While the coprocessor card A 202 is illustrated, coprocessor cards B-Q (blocks 204 and 206 respectively) may be similarly constructed and configured. The functionality described herein may also be implemented on logical elements of one or more integrated circuits.

As illustrated in FIG. 3, the coprocessor card A 202 is configured to provide accelerated market data and one more CPUs (such as CPU 210) with multiple cores, such as cores 1-n (blocks 320, 330, 340 and 350 respectively). In an embodiment, the coprocessor card A 202 comprises a data feed handler 306 and a multi-channel network interface 310 that connects to the network 225. The data feed handler 306 and the multi-channel network interface 310 may be implemented on one or more processors such as a field programmable gate array (FPGA).

The coprocessor card A 202 may be configured by a user to receive data elements from one or more data sources A and to receive content identifiers from content identifier and key datastore 230 (FIG. 2).

The data feed handler 306 may, based upon user input, assign a content identifier to a data element. The content identifier may be used to route data elements to memory, such as data books 1-n (blocks 322, 332, 342 and 352 respectively) associated with a particular processor core and to data consumers such as data consumers A-R (blocks 242, 244, 246 and 248 respectively) as described below. In an embodiment, the transfer of the data elements to and from a memory is performed using direct memory access (DMA) 360 over a high-speed interface 308 such as HyperTransport, PCI-Express or Quick Path Interconnectbus architecture.

The DMA 360 interacts with the cores 1-n and the data books 1-n via an API, such as API 324. In an embodiment, the API 324 provides an input/output queue for the data blocks associated with each of the cores of the CPU 210.

Referring again to FIG. 2, the content identifier and key datastore 230 is configurable by a user of the data distribution system 200. In an embodiment, the content identifier and key datastore 230 comprises a mapping of content identification information to a content identifier. For example, a data element of interest may be present in one or more a data streams and identifiable by a unique alpha-numeric string (the content identification information).

Using standard technology, a data element of interest may be found by searching the data streams for the alpha-numeric string and passing the data streams containing the alpha-numeric to data consumers interested in that particular data element. Such a process typically requires calls to the OS and various OS peripherals and places computational demands on the resident CPU. In contrast to such stream filtering methods, in this embodiment, the content identification information is mapped to a simple content identifier at the content identifier and key datastore 230 before the data streams are processed. By way of illustration and not by way of limitation, the content identifier is an integer. The mapping is used by the data feed handler 306 to identify data elements of interest in the various data streams and to assign the data elements of interest its content identifier. Thus, the data stream may be screened for data elements of interest without the use of a CPU and without the inherent latency of CPU-OS interactions.

The content identifiers may be used to send the particular data elements of interest to specific cores such as cores 1-n (blocks 320, 330, 340 and 350 respectively). The data elements are received in memory blocks and processed into “data books” such as data books 1-n (blocks 322, 332, 342 and 352 respectively) associated with a particular processor core to which the data elements of interest have been assigned.

The routing of data elements to the cores 1-n (blocks 320, 330, 340 and 350 respectively) provides a filtering function that exposes the cores to only that data that the user has determined is important. The number of data books that may be filtered from a data stream is limited only by the number of cores that are available to receive them. By performing the filtering function in a processor and transferring data using DMA the OS and its peripherals are avoided resulting in a significant reduction in latency over other methods of data filtering that make calls to the OS.

The content of the data books may be distributed to data consumers such as data consumers A-R (blocks 242, 244, 246 and 248 respectively) via a multi-channel network interface 310 that connects to the network 225.

The distribution of the channel data (block 2) is configurable via a user accessible control channel (block 1).

In an embodiment, the data channels (block 1) may be implemented on a 10 Gigabit Ethernet LAN, with an upgrade path to 40 Gigabit and 100 Gigabit Ethernet. The data injected into the fast-switched network environment will have specific content IDs that are filtered at the hardware level (as, for example, in an FPGA residing on co-processor card 202 and not the CPU cores). As a result, maximum server resources will be available for value added processing, rather than dealing with data distribution, leading to a much reduced processing footprint. Given the capacity of fast-switched networks and the hardware accelerated content filtering, multiple datasets may be distributed on separate broadcast channels, providing flexibility in the configuration of data architectures.

The data books may be “consumed” by data consumers connected to the network 225 such as data consumers A-R (blocks 242, 244, 246 and 248 respectively). By way of illustration and not by way of limitation, a data consumer may only be interested in a particular data element or group of data elements. A data consumer may be configured to select the data elements of interest off the network 225 using the content identifier or identifiers assigned to the data elements.

The content identifier and key datastore 230 may also be used to allocate an internal security identifier so that the whole architecture is protected by hardware based security. Additionally, when the data feed handler 306 and the multi-channel network interface 310 are implemented on a programmable gate array (FPGA), the distribution components cannot be reprogrammed or spoofed via the network. Thus, the architecture will be extremely secure and may not require software-based firewalls, which add to overall latency.

In an embodiment, the switch 220 is a 10 GigE switch and the network 225 is a 10 GigE local area network. However, this is not meant as a limitation. The speed of the switch 220 and the network 225 are anticipated to be at the upper range of the reliable transport speeds. Data transmission over the fast-switched network may be managed using UDP or TCP/IP protocols or directly at the Ethernet frame level, thus avoiding the overhead of protocols such as UDP and TCP/IP. In the case of direct Ethernet transmission, an Ethernet packet of the required length will be transmitted comprising the Ethernet header, a system header (comprising the data channel and relevant content identifiers) and the data payload.

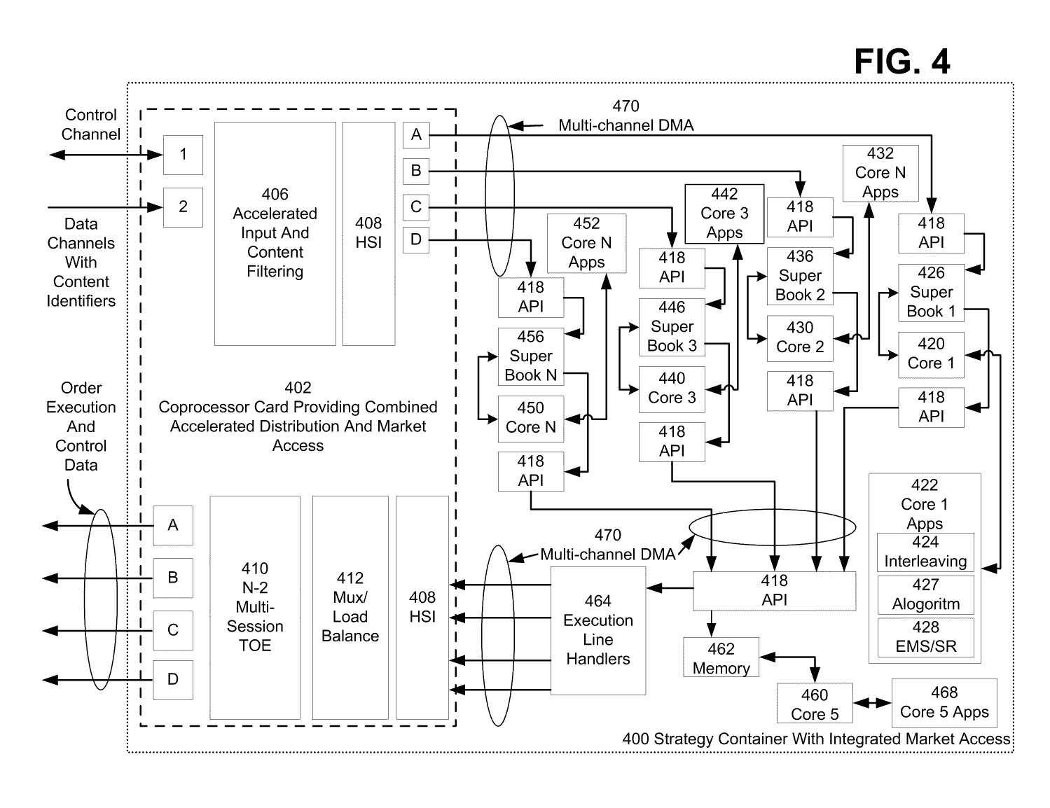

FIGS. 4-7 are block diagrams illustrating various data consumers in a financial data routing system according to embodiments. The data consumers are illustrative but not limiting. The configuration and functionality of a data consumer may depend at least in part on the data being consumed and the purpose for which it is being consumed.

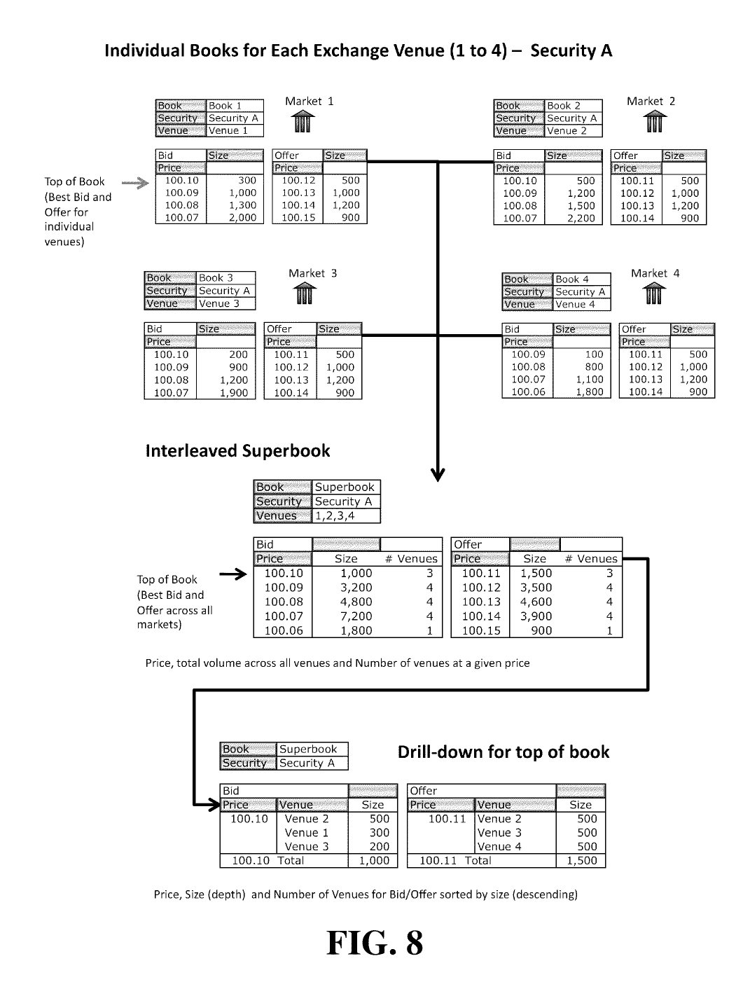

In the description that follows, reference may be made to the terms “book” or “order book” and “superbook.” FIG. 8 is a block drawing illustrating the concepts of a book and a superbook as known in the art. An order book provides bid/offer and size for a particular security in real time for all price levels available for a particular exchange venue. An interleaved superbook consolidates data from multiple order books providing real-time bid/offer and total lot size available across all markets. A superbook may include a drill-down feature that shows the lot size available from each venue contributing to size at a particular price point and a further drill down to the individual order level.

Referring again to FIGS. 2 and 3, the data sources A-Q may be market data from sources such as for example, Nasdaq, ARCA, BATS, and Direct Edge. The data books 1-n residing in memory (blocks 322, 332, 342 and 352 in FIG. 3 respectively) may be market books. The cores may be configured to various types of market data based on the content identifier assigned to that data as described above. These data are then passed through the multi-channel network interface 310 that connects to the network 225. The data channel data (block 1, FIG. 3) may, for example, include raw exchange market data format, normalized (cross market) format, book and book update format, book snapshot format and index data. These data are consumed by the various data consumers such as data consumers A-R (blocks 242, 244, 246 and 248 of FIG. 2 respectively).

FIG. 4 is a block diagram illustrating components of an algorithm/strategy container with local execution according to an embodiment.

In an embodiment, a strategy container 400 comprises one or more coprocessor cards, such as coprocessor card 402. As indicated in the description of FIG. 1, the coprocessor card 402 may include one or more co-processors. A coprocessor may be a field programmable gate array (FPGA), an application specific integrated circuit (ASIC), or any form of parallel processing integrated circuit. In this embodiment, the one or more coprocessor cards are configured to provide accelerated distribution and market access functions.

The coprocessor card 402 may be configured to provide an accelerated input and content filtering function 406. The accelerated input and content filtering function 406 may be configured via a control channel (block 1) to consume relevant filtered data selected from the data channels using content identifiers (block 2).

Given the capacity of fast-switched networks and the hardware accelerated content filtering, both “raw” and processed data may be distributed without loss of performance or throughput. In the trading and market data embodiments described below, multiple datasets may be distributed on separate broadcast channels, providing flexibility in the configuration of data architectures:

TABLE 1

| | |
|---|---|
| Raw Exchange Data | Raw market data specific to each |
| | execution venue |
| Generalized Market Data | Normalized market data with a |
| | common format across multiple |
| | exchanges |
| Book & Book Update | Full depth order book with order book |
| | delta update stream |
| Book Snapshot | Snapshot of full depth order book |
| Index (tick by tick) | Security index comprising a |
| | compilation of prices of common |
| | entities into a single number |

The filtered data elements are passed via a high-speed interface (HIS) 408 such as HyperTransport, PCI-Express or Quick Path Interconnect to selected memory blocks, such as memory blocks 426, 436, 446, and 456 respectively, associated with the cores of one or more multi-core CPUs such as cores 1-4 (blocks 420, 430, 440, 450 and 460 respectively). While five cores are illustrated for clarity, the number of cores is not so limited.

For discussion purposes, only the functional elements associated with the core 1 420 are illustrated in detail. However, the cores 2-4 (blocks 430, 440, and 450 respectively) may be associated with similar functional elements to perform particular functions as assigned by the user of the strategy container 400.

The cores 1-4 (blocks 420, 430, 440, and 450 respectively) may be associated with specific memory blocks, such as memory blocks 426, 436, 446, and 456 respectively. As illustrated in FIG. 4, the memory blocks are identified as superbooks 1-N but this is not meant as a limitation. The memory blocks will receive data in accordance with the configuration of the strategy container 400. The cores 1-4 may be configured to receive selected data elements via an API 418. The API 418 permits the DMA to write and read directly to the memory associated with a particular core without requiring calls to the OS.

The core 1 420 is associated with core 1 applications 422. Cores 2, 3, and 4 may also be associated with core applications, such as core 2 applications 432, core 3 applications 442 and core N applications 452. However, the applications associated with cores 2, 3, and 4 are not illustrated for the sake of clarity.

In this embodiment, the data elements received by the memory block 426 may be interleaved via an interleaving function 424 and stored as an interleaved superbook in the memory block 426 as described above. The interleaved super-book may then be processed according to particular algorithm(s) 427 running on the core 1 420. By way of illustration and not by way of limitation, an algorithm 427 may monitor the price of a security on multiple exchanges. When an arbitrage opportunity arises, such as a discontinuity in price between different forms (e.g. index versus underlying security or option), the algorithm 427 may issue buy and sell orders to the exchanges for a predetermined quantity of stock. Alternatively, if a buy order, because of quantity, requires purchases of the desired security on different exchanges, orders are generated accordingly. Each of the other cores may receive particular data elements, construct data books and operate on the data books using algorithms selected for the particular core.

In this configuration, each user specified strategy/algorithm will also have access to an execution management system (EMS) or smart order router (SR) application 428 that manages order execution including semantic translation, order state and stop loss, with bi-directional market access (both order executions, acknowledgements, order status and fills). By way of illustration and not by way of limitation, a smart order router application 428 may monitor the offer prices for a security on various exchanges. In order to minimize the effects of offering a large block of a security on a single market, the smart router application 428 may divide the block into smaller blocks for sale on multiple exchanges. The smart router application 428 may also arrange to sell (or buy) securities serially or simultaneously.

The processed data for each of the cores 1-4 (blocks 420, 430, 440, and 450 respectively) may be referred to a memory block 462 associated with the core 5 460 via API 418. In this embodiment, core 5 460 interacts with one or more execution line handlers 464 and core 5 applications 468. The core 5 460 creates orders based on the strategies implemented in the various algorithms applied to the data elements by the cores and directs those orders to the appropriate markets. The line handlers 464 receive those orders and place them in a format acceptable to the exchange to which they are directed.

The data exchanges to, from and between the cores may be performed using multi-channel direct memory access (DMA) 470. The data are passed over a high-speed interface (HIS) 408 such as HyperTransport, PCI-Express or Quick Path Interconnect.

The coprocessor card 402 is further configured to provide multiplexing and load balancing functions (block 412) and a multi-session TCP/IP offload engine (block 410). The MUX/load balancing functions (block 412) facilitate the establishment of multiple sessions with a particular exchange. Multiple sessions allows data loading to be managed for efficiency and for resilience and redundancy purposes. Since this component will be able to determine the loading and performance of a particular TCP/IP session, it will be possible to perform load-balancing in-line. The multi-session TCP/IP offload engine (block 410) facilitates the offloading of processing of an entire TCP/IP stack to a network controller thereby by-passing the CPU.

The HSI 408, the API 418, the MUX/load balancing functions (block 412) and the multi-session TCP/IP offload engine (block 410), the memory block 462 and the execution line handlers 464 provide a generic API for access across all markets. The shared hardware accelerated market access component can be accessed via multiple cores simultaneously and may also contain data multiplexing and load balancing capabilities.

This combined functionality of the strategy container 400 significantly reduces the latency from user space (RAM) to wire and provides extremely deterministic performance (zero jitter) as the operating system is no longer involved. The strategy container component is thread-safe and provides access to both market data and order/execution data relevant to algorithm or trading strategy. Because the majority of the processing takes place in hardware and both market data input and execution API's include a parallel multi-channel DMA capability the container can service multiple cores very efficiently.

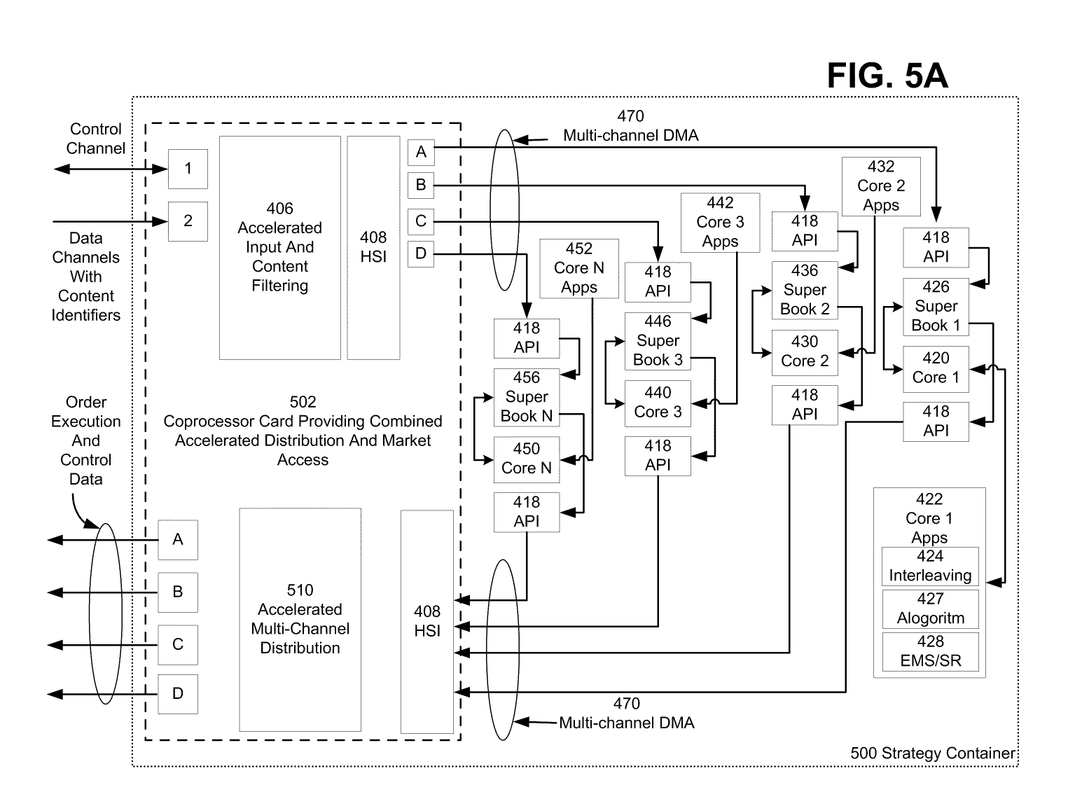

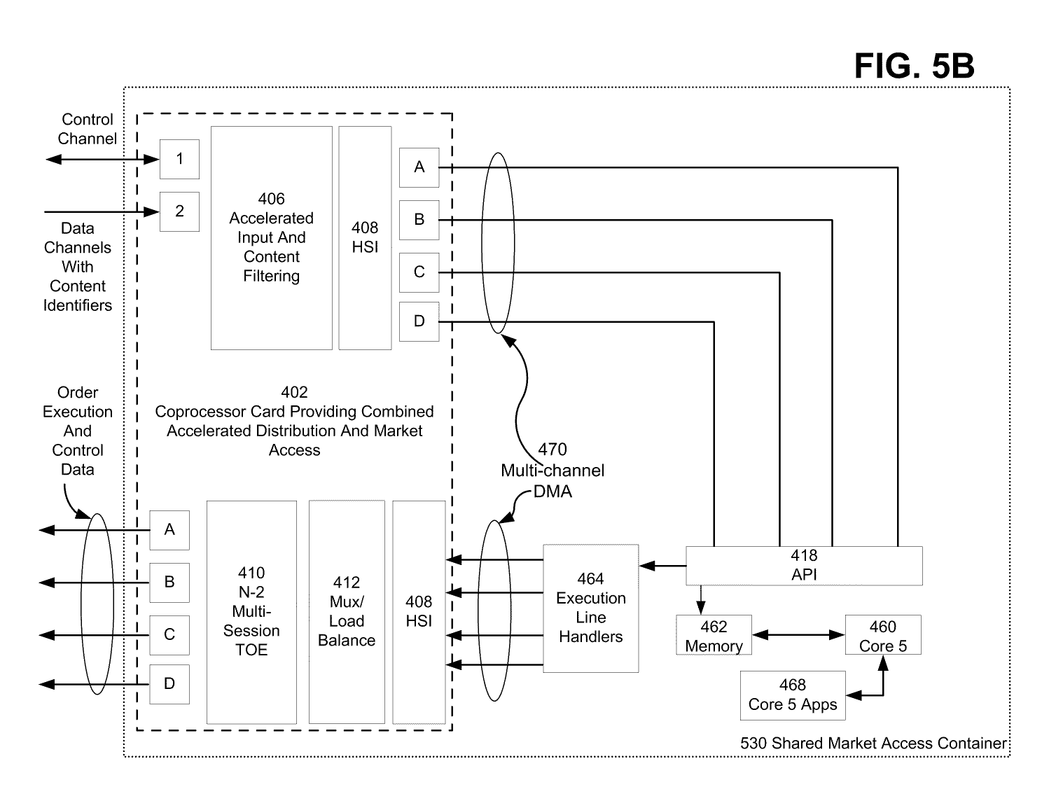

In another embodiment, the distribution components of a strategy container may be separate from the market access components of the strategy container. FIG. 5A is a block diagram illustrating a strategy container with distributed market access according to an embodiment.

The strategy container 500 comprises many of the same elements as the previously described strategy container 400. However, in this implementation, coprocessor card 502 distributes processed data to the network 225 (FIG. 2) via multichannel distribution functionality 510. As indicated in the description of FIG. 1, the coprocessor card 502 may include one or more co-processors. A coprocessor may be a field programmable gate array (FPGA), an application specific integrated circuit (ASIC), or any form of parallel processing integrated circuit.

FIG. 5B is a block diagram of a shared market access container according to an embodiment. The shared market access container 530 comprises many of the same elements as the previously described strategy container 400. However, in this implementation, coprocessor card 402 receives data processed by the strategy container 500 (FIG. 5A) from the network 225 (FIG. 2) and prepares orders based on those data for distribution to the appropriate markets. As indicated in the description of FIG. 1, the coprocessor card 402 may include one or more co-processors. A coprocessor may be a field programmable gate array (FPGA), an application specific integrated circuit (ASIC), or any form of parallel processing integrated circuit.

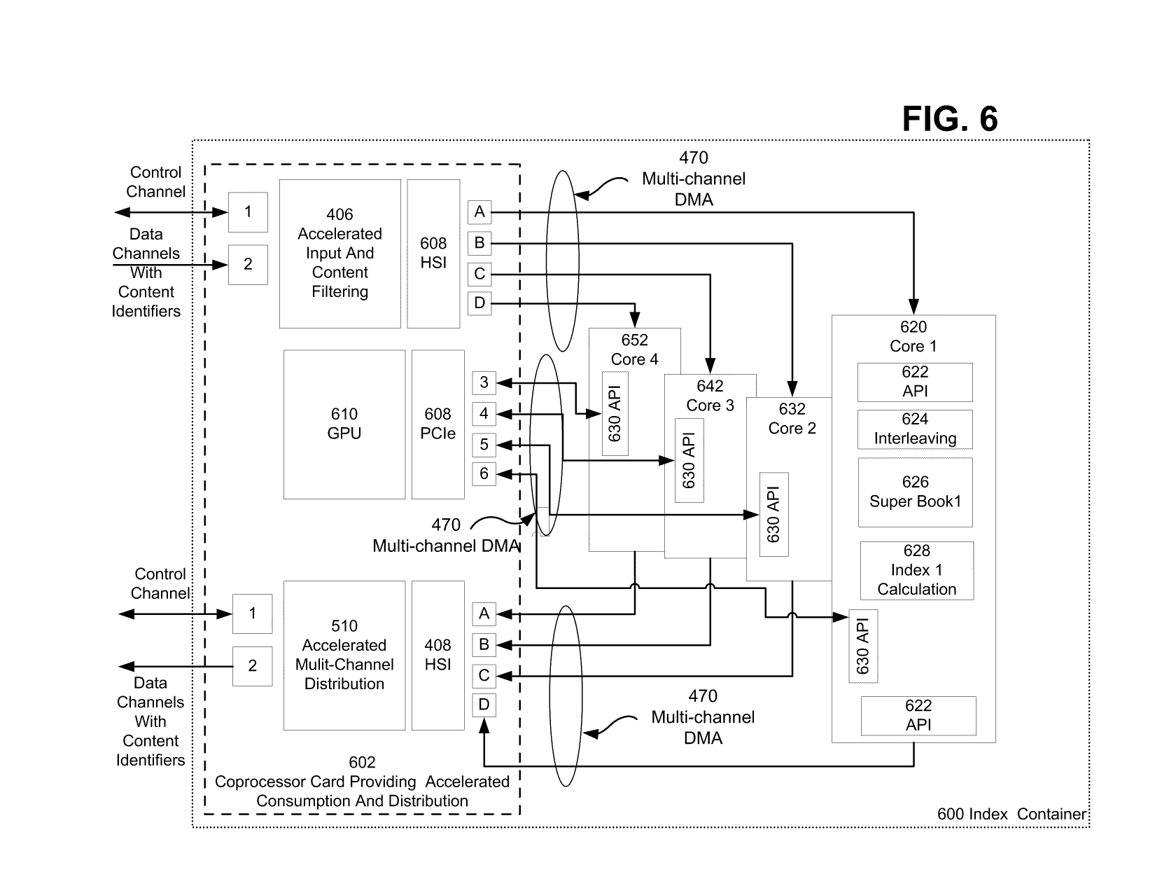

The shared market access container 530 may be used by other data consumers. The sharing of market access can be useful where load balancing, throughput management and/or cost of ownership are important consideration. The distributed market access component may support multiple-sessions connected to multiple execution venues (exchanges) and may provide data multiplexing and load-balancing. FIG. 6 is a block diagram illustrating components of an accelerated index container according to an embodiment.

In an embodiment, an index container 600 comprises one or more coprocessor cards, such as coprocessor card 602. As indicated in the description of FIG. 1, the coprocessor card 602 may include one or more co-processors. A coprocessor may be a field programmable gate array (FPGA), an application specific integrated circuit (ASIC), or any form of parallel processing integrated circuit. In this embodiment, the one or more coprocessor cards are configured to provide accelerated calculating of a synthetic index from multiple markets at line speed on a tick-by-tick basis.

The coprocessor card 602 may be configured to provide an accelerated input and content filtering function 406. The accelerated input and content filtering function 406 may be configured via a control channel (block 1) to consume relevant filtered data selected from the data channels using content identifiers (block 2). The filtered data elements are passed via the high speed interface 408 to selected cores of one or more multi-core CPUs such as cores 1-4 (blocks 420, 432, 442, and 452 respectively). By way of illustration and not by way of limitation, the HSI 408 may be implemented as HyperTransport, PCI-Express or Quick Path Interconnect. While four cores are illustrated for clarity, the number of cores is not so limited.

The index container 600 may also include a graphics processing unit (GPU) 610 to perform the index calculation. A GPU typically has around 60 times the number of cores as a standard processor and 10 times the double precision performance of a CPU at 1/10^{th} the power and cost. The core 1 applications 402 comprises an index calculation application 604. The index calculation application 604 makes calls to the GPU 610 via API 618 for specific mathematical computations. The results of these computations are then received by the index calculation application 604 and used to generate the index data that is then referred to core 1 420 and stored in memory location 426. The index data are then accessed via the API 418 and distributed processed data to the network 225 (FIG. 2) via the multichannel distribution functionality 510.

In an embodiment, an index container such as index container 600 consumes relevant filtered book and book update data on the input side and passes this information to one or more processing cores via multi-channel DMA. For example, the index container 600 may be configured to cause the processing cores to construct an interleaved Super-Book containing the top of book bid/offer and mid prices for one or more securities relevant to a particular index/indices running on that core and to leverage a multi-core GPU for accelerated double precision index calculations. The index results, which may be calculated on a tick-by-tick basis at line speed, may be distributed over a fast-switched network (such as network 225 illustrated in FIG. 2) on a broadcast channel with the appropriate content ID.

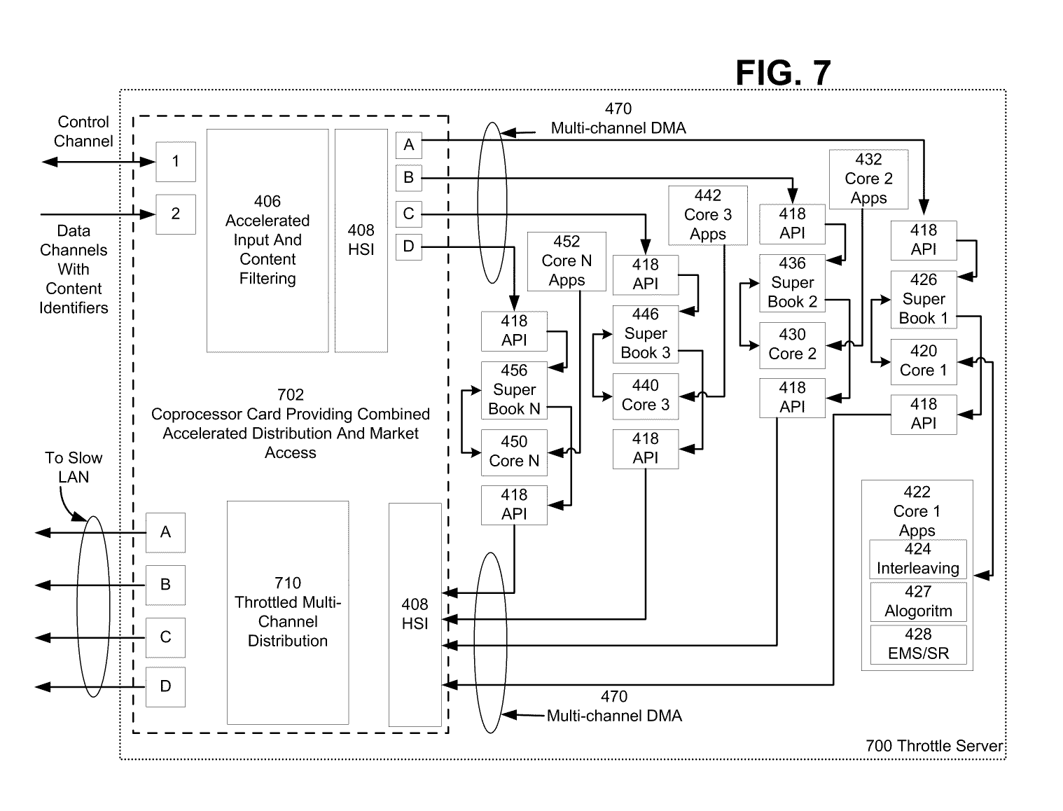

FIG. 7 is a block diagram illustrating components of a data throttling container according to an embodiment.

The throttle server 700 comprises many of the same elements as the previously described. The coprocessor card 702 may be configured to provide an accelerated input and content filtering function 406. The accelerated input and content filtering function 406 may be configured via a control channel (block 1) to consume relevant filtered data selected from the data channels using content identifiers (block 2). However, in this implementation, coprocessor card 702 provides “throttled” multichannel distribution functionality 510. As indicated in the description of FIG. 1, the coprocessor card 702 may include one or more co-processors. A coprocessor may be a field programmable gate array (FPGA), an application specific integrated circuit (ASIC), or any form of parallel processing integrated circuit.

In an embodiment, the throttle server maintains a copy of one or more data books updated at line speed. The “throttled” multichannel distribution functionality 710 allows an external server to poll this data at a slower rate and distribute the updates over a slower LAN via an appropriate protocol (UDP, TCP/IP etc.). The permits slower consumers who are not able to cope with the accelerated message throughput to utilize the processed data books via a slower data stream that is still synchronized and consistent with the near real-time data routing and processing as previously described. By way of illustration and not by way of limitation, the architecture described herein, in combination with the throttle server 700, simultaneously supports all known trading and market data use-cases from the highest frequency latency sensitive co-located algorithm to the slowest consumer of market data.

Various embodiments have been described in the context of distributing market data based on the content of that data. As will be appreciated by those skilled in the art, the described structures and processes may be applied to manage and distribute data of all kinds such as middle and back office data for a global investment bank, a multi-market securities and derivatives exchange, distributed transaction processing on secure networks such as ATM networks, e-commerce applications, telemetry and data collection from distributed sources, and information distribution, including surveillance information. In each of these cases, there would be significant benefits in terms of footprint, latency and utilization of network bandwidth.

The generalized architecture described herein offers an order of magnitude performance improvement over traditional software environments. This architecture offers significant benefits in terms of scalability, footprint, throughput, and eliminates latency jitter. The use of multi-core processors, multi-channel DMA and content-based data routing may also significantly reduce the number of servers and other hardware used to collect, route and process data thereby providing significant investment and operating cost savings. The reduction in hardware and the use of more efficient hardware may also significantly reduce the amount of energy consumed by business sectors that rely heavily on data management and could also provide upstream reductions in green-house gas production.

While the quest for ever greater performance and processing capacity poses significant challenges for companies in terms of data centre power, cooling and space requirements, it also has consequences for the environment. A recent report from the U.S. Environmental Protection Agency found that, in 2006, 1.5% of the U.S. national electricity demand came from energy consumption of data centers. It also found that the energy consumption of servers and data centers in the USA has doubled in the past five years and is expected to almost double again in the next five years to an annual cost of around $7.4 billion. Technology equipment has been estimated to account for about 10% of the UK's total electricity consumption (2), roughly the equivalent of four nuclear power stations. It has also been estimated that the global information and communications technology (ICT) industry accounts for approximately 2 percent of global carbon dioxide (CO2) emissions, a figure equivalent to the output of the aviation industry.

In embodiments, the hardware acceleration as described herein addresses the need for higher performance by offloading computationally intensive tasks from the server CPU to a field programmable gate array (FPGA) co-processor board. The FPGA achieves performance through massive parallelism and pipelining instead of a high clock speed and delivers extremely high performance per watt. By offloading work from the server CPU, it is possible to significantly improve application performance, while consuming considerably less power, requiring less cooling and less space. By way of illustration and not by way of limitation, the accelerated systems described herein typically consume 1/10th the power and provide at least a ten fold performance improvement over the equivalent CPU-based, software-only application.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next,” etc., are not intended to limit the order of a processes or method. Rather, these words are simply used to guide the reader through the description of the methods.

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

Furthermore, the novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” herein is not intended to indicate a desire to invoke the special provision of 35 U.S.C. 112, paragraph 6 to define the invention. To the contrary, if the provisions of 35 U.S.C. 112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. 112, paragraph 6. Moreover, even if the provisions of 35 U.S.C. 112, paragraph 6, are involved to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of the computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (DSL), or wireless technologies such as cellular, infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically and discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the principles and novel features disclosed herein. Further, any reference to claim elements in the singular, for example, using the articles “a,” “an,” or “the,” is not to be construed as limiting the element to the singular.

What is claimed is:

1. A system for filtering data comprising:
a central processing unit (CPU), wherein the CPU comprises a plurality of cores;
a content identifier datastore, wherein the content identifier datastore maps a particular content to a content identifier; and
a data filtering circuit accessible to the content identifier datastore comprising:
a first set of logical elements configured for receiving one or more data streams;
a second set of logical elements configured for receiving the content identifier for the particular content from the content identifier datastore;
a third set of logical elements configured for searching the one or more data streams for the particular content;
a fourth set of logical elements configured for associating the particular content with the content identifier; and
a fifth set of logical elements configured for routing the particular content to a memory block using the content identifier, wherein the memory block is associated with a particular core of the CPU and with the content identifier.

2. The system of claim 1, wherein the fifth set of logical components comprises a high speed interface.

3. The system of claim 2, wherein the high speed interface is selected from the group consisting of a HyperTransport interface, PCI-Express interface, and a Quick Path Interconnect interface.

4. The system of claim 1, wherein the fifth set of logical components is further configured to communicate with the memory block associated with the particular core of the first CPU using a direct memory access (DMA) architecture.

5. The system of claim 1, wherein the one or more data streams are selected from the group consisting of financial data streams, transactional data streams, telemetry data streams, and surveillance data streams.

6. The system of claim 1, wherein the particular content is in the form of an alph-numeric string.

7. The system of claim 1, wherein the content identifier is an integer.

8. The system of claim 1, wherein the data filtering circuit is implemented on one or more integrated circuits.

9. The system of claim 8, wherein the one or more integrated circuits are selected from the group consisting of a field programmable gate array and an application specific integrated circuit.

10. The system of claim 1, wherein the first CPU resides in a computing device and wherein the data filtering circuit is implemented on a plug-in card that is operable by the computing device.

11. The system of claim 1, wherein the data streams are received by first set of logical elements via a high speed network.

12. The system of claim 11, wherein the high speed network is selected from the group consisting of a 10 Gigabit Ethernet LAN, a 40 Gigabit Ethernet LAN and a 100 Gigabit Ethernet LAN.

13. The system of claim 1 further comprising a data distribution circuit having access to the network and comprising a sixth set of logical elements configured for receiving data associated with the content identifier from the particular core and for distributing the data and the content identifier over a network.

14. The system of claim 11, wherein the high speed network is selected from the group consisting of a 10 Gigabit Ethernet LAN, a 40 Gigabit Ethernet LAN and a 100 Gigabit Ethernet LAN.

15. A method for filtering data from a data stream comprising:
maping a particular content to a content identifier;
receiving one or more data streams at a first set of logical elements of a data filtering circuit;
receiving the content identifier for the particular content at a second set of logical elements of the data filtering circuit;
searching the one or more data streams for the particular content at a third set of logical elements of the data filtering circuit;
associating the particular content with the content identifier at a fourth set of logical elements of the data filtering circuit; and
routing the particular content to a memory block at a fifth set of logical elements of the data filtering circuit using the content identifier, wherein the memory block is associated with a particular core of a multi-core CPU and with the content identifier.

16. The method of claim 15, wherein the fifth set of logical components comprises a high speed interface.

17. The method of claim 16, wherein the high speed interface is selected from the group consisting of a HyperTransport interface, PCI-Express interface, and a Quick Path Interconnect interface.

18. The method of claim 15, wherein the fifth set of logical components is further configured to communicate with the memory block associated with the particular core of the first CPU using a direct memory access (DMA) architecture.

19. The method of claim 15, wherein the one or more data streams are selected from the group consisting of financial data streams, transactional data streams, telemetry data streams, and surveillance data streams.

20. The method of claim 15, wherein the particular content is in the form of an alph-numeric string.

21. The method of claim 15, wherein the content identifier is an integer.

22. The method of claim 15, wherein the data filtering circuit is implemented on one or more integrated circuits.

23. The method of claim 22, wherein the one or more integrated circuits are selected from the group consisting of a field programmable gate array and an application specific integrated circuit.

24. The method of claim 15, wherein the first CPU resides in a computing device and wherein the data filtering circuit is implemented on a plug-in card that is operable by the computing device.

25. The method of claim 15, wherein the data streams are received by first set of logical elements via a high speed network.

26. The method of claim 25, wherein the high speed network is selected from the group consisting of a 10 Gigabit Ethernet LAN, a 40 Gigabit Ethernet LAN and a 100 Gigabit Ethernet LAN.

27. The method of claim 15 further comprising a data distribution circuit having access to the network and comprising a sixth set of logical elements configured for receiving data associated with the content identifier from the particular core and for distributing the data and the content identifier over a network.

28. The method of claim 27, wherein the high speed network is selected from the group consisting of a 10 Gigabit Ethernet LAN, a 40 Gigabit Ethernet LAN and a 100 Gigabit Ethernet LAN.
